(19) United States
(12) Patent Application Publication
(10) Pub. No.: US 2010/0006165 A1
(43) Pub. Date: Jan. 14, 2010

(54) HYDRAULICALLY ACTUATED PNEUMATIC REGULATOR

(75) Inventors: Paul Banta, Avondale, AZ (US); Todd Garrod, Gilbert, AZ (US)

Correspondence Address: HONEYWELL/IFL;Patent Services, 101 Columbia Road, P.O.Box 2245, Morristown, NJ, 07962-2245, US

(73) Assignee: Honeywell International Inc., Morristown, NJ (US)

(21) Appl. No.: 12/171,565

(22) Filed: Jul. 11, 2008

(51) Int. Cl. F15B 13/04

(52) U.S. Cl. 137/625.63

(57) ABSTRACT

A hydraulically actuated pneumatic regulator is configured to receive hydraulic fluid from a hydraulic source and pressurized air from a pressurized air source to control air pressure downstream of the pneumatic regulator. The hydraulically actuated pneumatic regulator includes a valve element, an actuator, and pneumatic-to-hydraulic servo. The actuator is adapted to receive one or more pneumatic control signals supplied by the pneumatic-to-hydraulic servo, and is operable, in response to the pneumatic control signals, to control the air pressure downstream of the pneumatic regulator.

### TECHNICAL FIELD

The present invention generally relates to pneumatic regulating valves, and more particularly to pneumatic regulating valves configured to control bleed air in a pneumatic system and the actuation and control of the pneumatic regulating valves.

### BACKGROUND

A gas turbine engine may be used to supply power to various types of vehicles and systems. For example, gas turbine engines may be used to supply propulsion power to an aircraft. Many gas turbine engines include at least three major sections, a compressor section, a combustor section, and a turbine section. The compressor section, which may include two or more compressor stages, receives a flow of intake air and raises the pressure of this air to a relatively high level.

In addition to providing propulsion power, a gas turbine engine may also, or instead, be used to supply either, or both, electrical and pneumatic power to the aircraft. For example, some gas turbine engines include a bleed air port on the compressor section. The bleed air port allows some of the compressed air from the compressor section to be bled away from the compressor and diverted away from the combustor and turbine sections, and used for other functions such as, for example, the aircraft environmental control system, and/or cabin pressure control system.

Most modern commercial aircraft have numerous applications of pneumatic control valves including pressure regulating valves that are configured to control the flow of air bled from the engine compressor. For practical considerations, most commercial aircraft bleed air valves are actuated pneumatically using the same source of engine bleed air. These pneumatically actuated valves may experience reliability issues due to air contamination. In addition, in many instances the engine bleed air pressure may be low and necessitate the use of relatively large pneumatic actuators. There has been a trend in the aircraft industry to use hydraulic actuation, often incorporating jet fuel as the source of hydraulic power, to replace pneumatic actuators on some pneumatic valve applications. The fuel, or other hydraulic fluid, is inherently cleaner than bleed air, which reduces the likelihood of contamination problems. In addition, the hydraulic pressure is generally high, thus a smaller actuator can be used. The existing hydraulically actuated pneumatic valves typically use an electro-hydraulic servo valve (EHSV) and a linear variable differential transformer (LVDT) or rotary variable differential transformer (RVDT) for control, along with some form of electronic computer. These components can increase overall system weight and, concomitantly, overall system cost.

Hence, there is a need for a hydraulically actuated pneumatic regulator that may be used in a bleed air system that can be actuated more efficiently to control the bleed air extracted from the engine. In addition, there is a need for a pneumatic regulating valve that enables bleed air pressure to be controlled without the use of electronic control components.

### BRIEF SUMMARY

The present invention provides a hydraulically actuated pneumatic regulator for control of fluid in a flow passage. In one embodiment, and by way of example only, the pneumatic regulator includes a valve element, a pneumatic-to-hydraulic servo, and an actuator. The valve element is disposed at least partially within the flow passage and movable to control a fluid flow therein. The pneumatic-to-hydraulic servo includes a hydraulic flow passage in fluidic communication with a hydraulic nozzle and fluidly communicates with a hydraulic inlet and a hydraulic outlet. The actuator is coupled to the valve element and the pneumatic-to-hydraulic servo. The actuator is responsive to one or more control signals supplied by the pneumatic-to-hydraulic servo to controllably move the valve element.

In another particular embodiment, and by way of example only, the pneumatic regulator includes a valve element, a pneumatic-to-hydraulic servo, a feedback conduit and an actuator. The valve element is disposed at least partially within the flow passage and movable to control fluid flow therein. The pneumatic-to-hydraulic servo includes a hydraulic flow passage in fluidic communication with a hydraulic nozzle, a flexible flapper in communication with the hydraulic nozzle, and a feedback pressure device in communication with the flexible flapper. The feedback pressure device is configured to disengage the hydraulic nozzle in response to a change in pressure and supply one or more control signals to control a flow of hydraulic fluid therethrough the hydraulic nozzle. The feedback conduit includes an inlet port in communication with the flow passage and the feedback pressure device. The actuator is coupled to the valve element and the pneumatic-to-hydraulic servo. The actuator is responsive to the one or more control signals supplied by the pneumatic-to-hydraulic servo to controllably move the valve element.

In yet another particular embodiment, and by way of example only, the pneumatic regulator includes a butterfly valve element, a pneumatic-to-hydraulic servo, a feedback conduit, and an actuator. The butterfly valve element is disposed at least partially within a bleed air flow passage and movable to control fluid flow therein. The pneumatic-to-hydraulic servo includes a hydraulic flow passage in fluidic communication with a hydraulic nozzle, a flexible flapper in communication with the hydraulic nozzle, and a feedback pressure device in communication with the flexible flapper. The feedback pressure device is configured to supply pneumatic signals generated by a differential pressure to disengage the hydraulic nozzle and control a flow of hydraulic fluid therethrough the hydraulic nozzle. The feedback conduit includes an inlet port in communication with the bleed air flow passage and the feedback pressure device. The actuator is coupled to the butterfly valve element and the pneumatic-to-hydraulic servo. The actuator is responsive to the pneumatic signals supplied by the pneumatic-to-hydraulic servo to controllably move the butterfly valve element.

Other independent features and advantages of the preferred hydraulically actuated pneumatic regulator will become apparent from the following detailed description, taken in conjunction with the accompanying drawings which illustrate, by way of example, the principles of the invention.

### BRIEF DESCRIPTION OF THE DRAWINGS

The present invention will hereinafter be described in conjunction with the following drawing figures, wherein like numerals denote like elements, and wherein:

FIG. 1 is a simplified representation of a bleed air system according to an exemplary embodiment;

FIG. 2 is a simplified representation of an exemplary embodiment of a hydraulically actuated pneumatic regulator that may be used to implement the system of FIG. 1; and

FIG. 3 is a simplified representation of an exemplary embodiment of a portion of the hydraulically actuate pneumatic regulator, and more particularly the pneumatic-to hydraulic servo, according to an alternate embodiment.

### DETAILED DESCRIPTION OF A PREFERRED EMBODIMENT

The following detailed description is merely exemplary in nature and is not intended to limit the invention or the application and uses of the invention. Furthermore, there is no intention to be bound by any theory presented in the preceding background or the following detailed description. In this regard, although the present embodiment is, for ease of explanation, depicted and described as being implemented in an aircraft gas turbine engine bleed air system, it will be appreciated that it can be implemented in various other systems and environments.

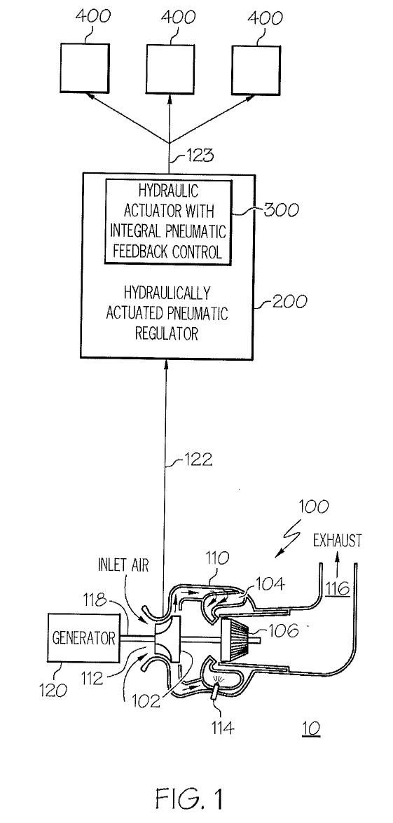

Turning now to FIG. 1, a simplified representation of a bleed air system 10 that may be used to supply bleed air to, for example, an environmental control system, is depicted. The system 10 includes a gas turbine engine 100, a hydraulically actuated pneumatic regulating valve 200, and at least one downstream component 400. The gas turbine engine 100 includes a compressor 102, a combustor 104, and a turbine 106, all disposed within a case 110. The compressor 102, which is preferably a multi-stage compressor, raises the pressure of air directed into it via an air inlet 112. The compressed air is then directed into the combustor 104, where it is mixed with fuel supplied from a fuel source (not shown). The fuel/air mixture is ignited using one or more igniters 114, and high energy combusted air is then directed into the turbine 106. The combusted air expands through the turbine 106, causing it to rotate. The air is then exhausted via an exhaust gas outlet 116. As the turbine 106 rotates, it drives, via a shaft 118 coupled to the turbine 106, equipment in, or coupled to, the engine 100. For example, in the depicted embodiment the turbine 106 drives the multi-stage compressor 102 and a generator 120 coupled to the engine 100. It will be appreciated that the gas turbine engine 100 is not limited to the configuration depicted in FIG. 1 and described herein, but could be any one of numerous types of gas turbine engines, such as a turbofan gas turbine engine that includes multiple turbines, multiple spools, multiple compressors, and a fan. Moreover, a gas turbine engine need not be the source of the bleed air that is supplied to the remainder of the system 10.

Preferably, a bleed air duct 122 is coupled between the multi-stage compressor 102 and the pneumatic regulating valve 200. The bleed air duct 122 is in fluid communication with the multi-stage compressor 102. In one particular embodiment, the bleed air duct 122 includes a plurality of ducts, namely a low-pressure stage duct, a mid-pressure stage duct, and a high-pressure stage duct, each in fluid communication with a different stage in the multi-stage compressor 102. It will additionally be appreciated that the system 10 could be implemented with any number of bleed air ducts 122 coupled to more than three different compressor stages, if needed or desired.

In the illustrated embodiment, bleed air from the compressor 102 is supplied to the pneumatic regulating valve 200 via the bleed air duct 122. The pneumatic regulating valve 200 is coupled to the bleed air duct 122 and the downstream duct 123. The pneumatic regulating valve includes a hydraulic (fuel or other hydraulic source) actuator with integral pneumatic feedback control 300 for controlling the flow of air bled from the multi-stage compressor 102 to at least one downstream component 400. No matter its specific physical implementation, the pneumatic regulating valve 200 is configured to selectively allow bleed air from the bleed air duct 122 to be controlled and regulated. In contrast to typical hydraulically actuated pneumatic valves that may include a control unit, such as an EHSV and an LVDT or RVDT, in conjunction with a computer, that are configured to supply appropriate commands to a valve, the pneumatic regulating valve 200 includes the hydraulic actuator with integral pneumatic feedback control 300 that operates to control the flow of bleed air without the need for any further control unit.

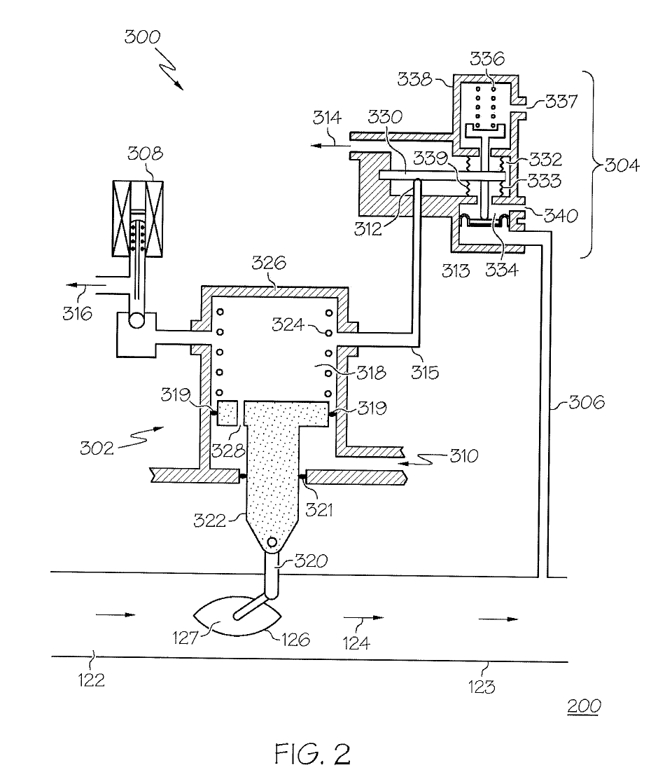

Turning to FIG. 2, one exemplary embodiment of the pneumatic regulating valve 200, including the hydraulic actuator with integral pneumatic feedback control 300, is depicted and will now be described in more detail. The depicted pneumatic regulating valve 200, and more particularly the hydraulic actuator with integral pneumatic feedback control 300 includes an actuator 302, a pneumatic-to-hydraulic servo, generally referenced 304, a feedback conduit 306, and an optional solenoid 308 to control an active/closed function of the pneumatic regulating valve 200. The actuator with integral pneumatic feedback control 300 further includes a hydraulic supply input 310, a first hydraulic output 314, an optional second hydraulic output 316, and a flow passage 315. The flow passage 315 fluidly communicates the actuator opening chamber 318 with the pneumatic-to-hydraulic servo 304. The bleed air duct 122 and the downstream duct 123 are illustrated having a flow of bleed air 124 therethrough indicated by directional arrows. The flow of bleed air 124 is controlled via a valve element 126 that in this particular embodiment is illustrated as a butterfly valve 127. The valve element 126 is movably disposed within the bleed air duct 122 and the downstream duct 123 and coupled to the actuator 302 via a linkage 320. The position of the valve element 126 controls air flow through the bleed air duct 122 and the downstream duct 123 and thereby controls the flow of air supplied to the at least one downstream component 400 (FIG. 1) and the feedback conduit 306.

The position of the valve element 126 is controlled by the actuator 302, which may include a piston and rod 322, and an optional bias spring 324. The piston and rod 322 is coupled to the valve element 126 via the linkage 320 and is disposed in an actuator enclosure 326. The optional bias spring 324 is disposed between the piston and rod 322 and the actuator enclosure 326 and supplies a bias force to the piston and rod 322 that biases the linkage 320 and in turn moves the valve element 126. The control orifice 328 provides a restricted fluid communication between the hydraulic supply input 310 and the actuator opening chamber 318. The control orifice 328 may be included in the piston and rod 322 as shown or could be incorporated in the actuator enclosure 326. In addition to being an integral part of the control system the control orifice 328 allows for a continuous flow of hydraulic fluid through the valve actuator 302 which may provide cooling and also prevent the buildup of residue caused by heating of stagnant hydraulic fluid. The piston and rod 322 also includes a piston seal 319. A rod seal 321 (or multiple seals) is incorporated into the actuator enclosure 326.

As FIG. 2 also depicts, a portion of the bleed air 124 flowing through the bleed air duct 122 and downstream duct 123 is also directed into the pressure feedback conduit 306. The pressure feedback conduit 306 is in fluid communication with the downstream duct 123 and the pneumatic-to-hydraulic servo 304.

The pneumatic-to-hydraulic servo 304 includes a flexible flapper 330, a hydraulic nozzle 312, an upper bellows 332, a lower bellows 333, an actuating rod 334, an optional additional feedback pressure device (a diaphragm is depicted) 313 and a calibration spring 336 disposed within a housing 338. The hydraulic nozzle 312 is in fluid communication with the hydraulic outlet 314 defined by the housing 338. The motion of the flexible flapper 330 with respect to the hydraulic nozzle 312 creates a variable hydraulic fluid flow metering area. The upper bellows 332 and lower bellows 333 are sealed and minimize hydraulic leakage at a pneumatic-to-hydraulic interface 339. As depicted the upper bellows 332 and the lower bellows 333 are exposed to ambient pressure via conduit 337 and optional conduit 340 respectively in the housing 338. Optionally the conduits 337 and 340 could instead be connected to a reference pressure source depending on the application requirements.

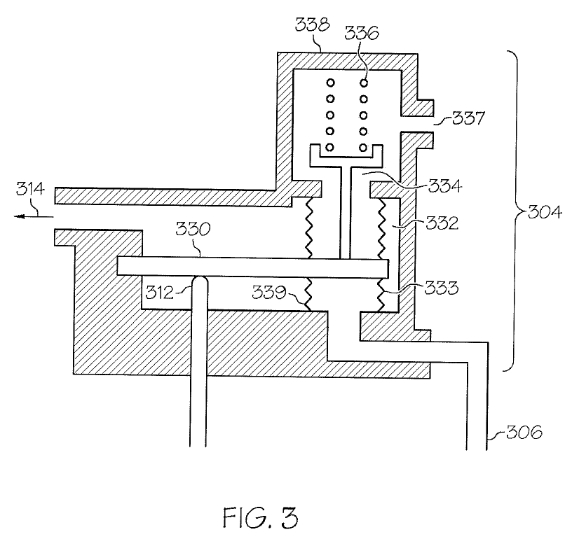

In an alternate embodiment, as best illustrated in FIG. 3, wherein only the pneumatic-to-hydraulic servo 304 is illustrated, the pneumatic-to-hydraulic servo 304 does not includes the feedback pressure device 313 and conduit 340. The function of the optional feedback device is integrated into the lower bellows 333. For this configuration the feedback conduit 306 would be attached directly to the lower bellows 333 allowing for the elimination of the optional feedback pressure device 313 and also thus requiring the elimination of the optional conduit 340.

Referring again to FIGS. 2 and 3, during active operation of the pneumatic regulating valve 200, and in particular the actuator with integral pneumatic feedback control 300, a hydraulic fluid flows into the actuator 302 via the hydraulic input 310, proceeds through the control orifice 328 into the actuator opening chamber 318, on through the flow passage 315, through the hydraulic nozzle 312, past the flexible flapper 330 and is discharged from the pneumatic-to-hydraulic servo 304 out through the hydraulic outlet 314.

The piston and rod 322 will move due to forces created by differential pressure induced by the hydraulic flow through the actuator 302. Hydraulic fluid entering the actuator 302 through the hydraulic inlet 310 tends to push the piston and rod 322 upwards, pulling on the linkage 320 and closing the valve element 126. Hydraulic fluid passing on through the control orifice 328 tends to fill the actuator opening chamber 318 which will push the piston and rod 322 downwards, pushing on the linkage 320 and opening the valve element 126. Similarly, hydraulic fluid exiting the actuator opening chamber 318 through the hydraulic nozzle 312 via the flow passage 315 tends to drain the actuator opening chamber 318 causing the piston and rod 322 to move upwards pulling on the linkage 320 and closing the valve element 126.

The pressure of the bleed air 124 in the downstream duct 123 may be selectively directed to the pneumatic-to-hydraulic servo 304 and more particularly, to the feedback pressure device 313 to provide pneumatic control. The pressure acting on the feedback pressure device 313 results in an upward force applied through the actuating rod 334 to the flexible flapper 330 and is resisted by the force of the calibration spring 336. When the bleed air 124 pressure in the downstream duct 123 is high the force on the feedback pressure device 313 will overcome the force of the calibration spring 336 and bend the flexible flapper upward away from the hydraulic nozzle 312 increasing the hydraulic fluid flow out of the actuator opening chamber 318 ultimately causing the valve element 126 to move towards the closed position. Similarly, when the bleed air 124 pressure in the downstream duct 123 is low the force of the calibration spring 336 will overcome the force on the feedback pressure device 313 and the flexible flapper will bend downward toward the hydraulic nozzle 312 decreasing the hydraulic fluid flow out of the actuator opening chamber 318 ultimately causing the valve element 126 to move towards the open position.

Closing the valve element 126 tends to reduce the pneumatic pressure in the downstream duct 123. Similarly opening the valve element 126 tends to increase the pneumatic pressure in the downstream duct 123. Thus due to the combined functions of the pneumatic-to-hydraulic servo 304, the actuator 302 the valve element 126 and other associated features of the invention the pneumatic regulating valve 200 will reduce the pressure in the downstream duct 123 when it increases and similarly will increase the pressure in the downstream duct 123 when it decreases resulting in a nearly constant pressure control in the downstream duct 123.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention.

What is claimed is:

1. A hydraulically actuated pneumatic regulator for control of fluid in a flow passage, the hydraulically actuated pneumatic regulator comprising:
a valve element disposed at least partially within the flow passage and movable to control a fluid flow therein;
a pneumatic-to-hydraulic servo including a hydraulic flow passage in fluidic communication with a hydraulic nozzle, the pneumatic-to-hydraulic servo fluidly communicating with a hydraulic inlet and a hydraulic outlet; and
an actuator coupled to the valve element and the pneumatic-to-hydraulic servo, the actuator responsive to one or more control signals supplied by the pneumatic-to-hydraulic servo to controllably move the valve element.

2. The hydraulically actuated pneumatic regulator of claim 1, wherein the one or more control signals supplied to the pneumatic-to-hydraulic servo are pneumatic signals generated by a differential pressure.

3. The hydraulically actuated pneumatic regulator of claim 2, wherein the pneumatic-to-hydraulic servo further includes a feedback pressure device configured to control the differential pressure.

4. The hydraulically actuated pneumatic regulator of claim 3, wherein the pneumatic-to-hydraulic servo comprises:
an actuating rod coupled to the feedback pressure device and slidably disposed within a housing;
a flexible flapper in communication with the actuating rod and the hydraulic nozzle;
a calibration spring disposed within the housing and configured to supply a bias force to the actuating rod that biases the flexible flapper onto the hydraulic nozzle.

5. The hydraulically actuated pneumatic regulator of claim 4, further comprising:
a feedback conduit in communication with the feedback pressure device and a downstream duct, the feedback pressure device in communication with the flexible flapper to control the fluid flow out of the actuator via the flow passage, the flexible flapper configured to engage with the hydraulic nozzle to control a flow of hydraulic fluid therethrough the hydraulic nozzle.

6. The hydraulically actuated pneumatic regulator of claim 1, wherein the actuator comprises:
an actuator enclosure including a hydraulic inlet and a hydraulic outlet, the hydraulic inlet in fluid communication with a source of hydraulic fluid, the hydraulic outlet in fluid communication with the hydraulic nozzle;
a piston coupled to the valve element and slidably disposed within the actuator enclosure between the hydraulic inlet and the hydraulic outlet; and
a spring disposed within the actuator enclosure and configured to supply a bias force to the piston that biases the piston away from the hydraulic outlet.

7. The hydraulically actuated pneumatic regulator of claim 1, further including a solenoid in fluidic communication with the actuator.

8. The hydraulically actuated pneumatic regulator of claim 1, wherein the valve element is a butterfly valve.

9. The hydraulically actuated pneumatic regulator of claim 1, wherein the flow passage is an engine bleed air flow passage.

10. A hydraulically actuated pneumatic regulator for control of fluid in a flow passage, the hydraulically actuated pneumatic regulator comprising:
a valve element disposed at least partially within the flow passage and movable to control fluid flow therein;
a pneumatic-to-hydraulic servo including a hydraulic flow passage in fluidic communication with a hydraulic nozzle, a flexible flapper in communication with the hydraulic nozzle, and a feedback pressure device in communication with the flexible flapper, the feedback pressure device configured to disengage the hydraulic nozzle in response to a change in pressure and supply one or more control signals to control a flow of hydraulic fluid therethrough the hydraulic nozzle;
a feedback conduit in communication with the flow passage and the feedback pressure device; and
an actuator coupled to the valve element and the pneumatic-to-hydraulic servo, the actuator responsive to the one or more control signals supplied by the pneumatic-to hydraulic servo to controllably move the valve element.

11. The hydraulically actuated pneumatic regulator of claim 10, wherein the one or more control signals supplied by the pneumatic-to-hydraulic servo are pneumatic signals.

12. The hydraulically actuated pneumatic regulator of claim 11, wherein the feedback pressure device is configured to control a differential pressure across the actuator.

13. The hydraulically actuated pneumatic regulator of claim 10, wherein the actuator comprises:
an actuator enclosure including a hydraulic inlet and a hydraulic outlet, the hydraulic inlet in fluid communication with a source of hydraulic fluid, the hydraulic outlet in fluid communication with the hydraulic nozzle;
a piston coupled to the valve element and slidably disposed within the actuator enclosure between the hydraulic inlet and the hydraulic outlet; and
a spring disposed within the actuator enclosure and configured to supply a bias force to the piston that biases the piston away from the hydraulic outlet.

14. The hydraulically actuated pneumatic regulator of claim 10, wherein the pneumatic-to-hydraulic servo comprises:
an actuating rod coupled to the feedback pressure device and slidably disposed within a housing, the flexible flapper in communication with the actuating rod and the hydraulic nozzle; and
a calibration spring disposed within the housing and configured to supply a bias force to the actuating rod that biases the flexible flapper onto the hydraulic nozzle.

15. The hydraulically actuated pneumatic regulator of claim 10, further including a solenoid in fluidic communication with the actuator.

16. The hydraulically actuated pneumatic regulator of claim 10, wherein the valve element is a butterfly valve.

17. The hydraulically actuated pneumatic regulator of claim 10, wherein the flow passage is an engine bleed air flow passage.

18. A hydraulically actuated pneumatic regulator for control of fluid in a bleed air flow passage, the hydraulically actuated pneumatic regulator comprising:
a butterfly valve element disposed at least partially within the bleed air flow passage and movable to control fluid flow therein;
a pneumatic-to-hydraulic servo including a hydraulic flow passage in fluidic communication with a hydraulic nozzle, a flexible flapper in communication with the hydraulic nozzle, and a feedback pressure device in communication with the flexible flapper, the feedback pressure device configured to supply pneumatic signals generated by a differential pressure to disengage the hydraulic nozzle and control a flow of hydraulic fluid therethrough the hydraulic nozzle;
a feedback conduit in communication with the bleed air flow passage and the feedback pressure device; and
an actuator coupled to the butterfly valve element and the pneumatic-to-hydraulic servo, the actuator responsive to the pneumatic signals supplied by the pneumatic-to-hydraulic servo to controllably move the butterfly valve element.

19. The hydraulically actuated pneumatic regulator of claim 18, wherein the actuator comprises:
an actuator enclosure including a hydraulic inlet and a hydraulic outlet, the hydraulic inlet in fluid communication with a source of hydraulic fluid, the hydraulic outlet in fluid communication with the hydraulic nozzle;
a piston coupled to the butterfly valve element and slidably disposed within the actuator enclosure between the hydraulic inlet and the hydraulic outlet; and
a spring disposed within the actuator enclosure and configured to supply a bias force to the piston that biases the piston away from the hydraulic outlet.

20. The hydraulically actuated pneumatic regulator of claim 18, wherein the pneumatic-to-hydraulic servo comprises:
an actuating rod coupled to the feedback pressure device and slidably disposed within a housing, the flexible flapper in communication with the actuating rod and the hydraulic nozzle; and
a calibration spring disposed within the housing and configured to supply a bias force to the actuating rod that biases the flexible flapper onto the hydraulic nozzle.
